(19) United States
(12) Patent Application Publication
(10) Pub. No.: US 2026/0334450 A1
(43) Pub. Date: Oct. 29, 2026

(54) Biodegradable Insect Trap

(71) Applicant: Danimer IPCo, LLC, Bainbridge, GA (US)

(72) Inventors: Carol G. Leggett, Whigham, GA (US); Cheryl G. Ware, Whigham, GA (US)

(21) Appl. No.: 19/737,192

(22) Filed: Jul. 10, 2026

Related U.S. Application Data
(63) Continuation of application No. 17/945,213, filed on Sep. 15, 2022.
(60) Provisional application No. 63/244,285, filed on Sep. 15, 2021.

(51) Int. Cl. A01M 1/14; A01M 1/02

(52) U.S. Cl. CPC A01M 1/14; A01M 1/023

(57) ABSTRACT

A biodegradable insect trap is provided which includes a substrate having a first surface, an adhesive applied over at least a portion of the substrate first surface, and an insect attractant. The substrate may be made up of either: (1) a polymeric web is in turn made up of at least 50 weight percent polyhydroxyalkanoates or (2) a paperboard web having a coating layer applied over a least a portion of the paperboard web, wherein the coating layer is made up of at least 50 weight percent polyhydroxyalkanoates. According to the present disclosure, the adhesive is also made up of at least 50 weight percent polyhydroxyalkanoates.

### CROSS-REFERENCE TO RELATED APPLICATIONS

This application is a continuation of US patent application 17/945,213 filed on Sep. 15, 2022, which claims the benefit of US provisional application 63/244,285, filed Sep. 15, 2021, the contents of both applications are herein incorporated by reference in their entirety.

### FIELD

This disclosure relates to insect traps. More particularly, this disclosure relates to an insect trap which is formed from biodegradable materials.

### BACKGROUND

Insect traps are commonly used in residential and commercial settings. Insect traps are also particularly in agricultural settings for pest control, both for in large scale commercial agriculture and in small scale personal gardens. In each situation, the insect trap is typically formed from persistent, non-biodegradable materials. The insect traps will also commonly include an insecticide which may be harmful to humans and/or harmful to crops.

Consequently, in agriculture, the used insect trap must be removed from the field before the field can be tilled for use. Likewise, used insect traps must also eventually be removed from residential and commercial spaces.

In view of this, it would desirable to eliminate this step of used insect trap removal by providing an inset trap which did not have to be removed but could instead simply be tilled into the soil.

### SUMMARY OF THE INVENTION

In a first aspect, the present disclosure provides a biodegradable insect trap. In one embodiment, this insect trap is made up of a substrate having a first surface, an adhesive applied over at least a portion of the substrate first surface, and an insect attractant.

According to the present disclosure, the substrate may be made up of either: (1) a polymeric web is in turn made up of at least 50 weight percent polyhydroxyalkanoates or

(2) a paperboard web having a coating layer applied over a least a portion of the paperboard web, wherein the coating layer is made up of at least 50 weight percent polyhydroxyalkanoates. According to the present disclosure, the adhesive is also made up of at least 50 weight percent polyhydroxyalkanoates.

The structural form of the trap may vary in accordance with the present disclosure. In certain embodiments, the substrate is preferably made up of an elongate sheet which is suspended from an overhead support. In other embodiments, the substrate is preferably formed into an enclosure for trapping insects. In some embodiments, the substrate is preferably formed into a box for trapping insects, wherein the substrate first surface is disposed inside of the box.

According to certain embodiments, the insect attractant is preferably made up of a pheromone which is attractive to insects. In some instances, the insect attractant is preferably made up of a pheromone which is attractive to Diabrotica barberi; Diabrotica undecimpunctata; Diabrotica undecimpunctata howardi Barber; Cerotoma trifurcata; Hypena scabra; Nezara viridula; Acrosternum hilare; Euschistus servus; Pseudoplusia includens (Walker); Trichoplusia ni (Hubner); Anthonomus grandis; Aphis glycines (Matsumura); Epicauta sp. (pennsylvania; pestifera; fabricii); and/ or Chrysodeixis includens.

In certain embodiments, the pheromone is preferably applied as a coating over at least a portion of the substrate.

According to certain embodiments, the substrate is preferably made up of at least 80 weight percent polyhydroxyalkanoates.

Different forms of polyhydroxyalkanoates may be used in the substrate. In some embodiments, the substrate preferably includes poly-3-hydroxybutyrate-co-3-hydroxyhexanoate (“P(3HB-co-3HHx)”). In other embodiments, the substrate preferably includes a terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate having from 5 to 12 carbon atoms.

In some instances, the substrate may also include at least one addition one biodegradable polymer selected from the group consisting of polycaprolactone, polylactic acid, polybutylene succinate, polybutylene succinate-co-butylene adipate, polybutylene adipate terephthalate, and mixtures thereof.

Different forms of polyhydroxyalkanoates may also be used in the adhesive. In some embodiments, the adhesive preferably includes poly-3-hydroxybutyrate-co-3-hydroxyhexanoate (“P(3HB-co-3HHx)”). In other embodiments, the adhesive preferably includes a terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate having from 5 to 12 carbon atoms.

In some instances, the adhesive is also made up of a biodegradable tackifier, such as a collagen-based tackifier or a mucilage tackifier.

The insect trap is also biodegradable. According to certain embodiments, the insect trap is preferably biodegradable as determined by ASTM D5988. In certain other embodiments, the insect trap is preferably home compostable as determined by ASTM D6400.

In certain embodiments, the also preferably does not include any insecticide.

In a further aspect, the present disclosure also provides a method for capturing insects. According to one embodiment, this method includes the steps of positioning an insect trap over an agricultural field; capturing insects with the trap; and disposing of the trap by burying the trap in the agricultural field.

The insect trap used according to the method is made up of a substrate having a first surface, an adhesive applied over at least a portion of the substrate first surface, and an insect attractant. The substrate may be made up of either: (1) a polymeric web is in turn made up of at least 50 weight percent polyhydroxyalkanoates or (2) a paperboard web having a coating layer applied over a least a portion of the paperboard web, wherein the coating layer is made up of at least 50 weight percent polyhydroxyalkanoates. According to the present disclosure, the adhesive is also made up of at least 50 weight percent polyhydroxyalkanoates.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a cross-sectional view of an insect trap structure according to one embodiment of the present disclosure;

FIG. 2 is a perspective view of an insect trap, formed as a suspended strip, according to one embodiment of the present disclosure;

FIG. 3 is a perspective view of an insect trap, formed as an enclosure, according to one embodiment of the present disclosure;

FIG. 4 is a perspective view of an insect trap, formed as a funnel trap, according to one embodiment of the present disclosure; and

FIG. 5 is a perspective view of an insect trap, formed as a panel trap, according to one embodiment of the present disclosure.

### DETAILED DESCRIPTION

The present disclosure provides an insect trap which is constructed from biodegradable materials. In general, the insect trap includes at least a substrate, an adhesive applied over at least a portion of the substrate, and an insect attractant.

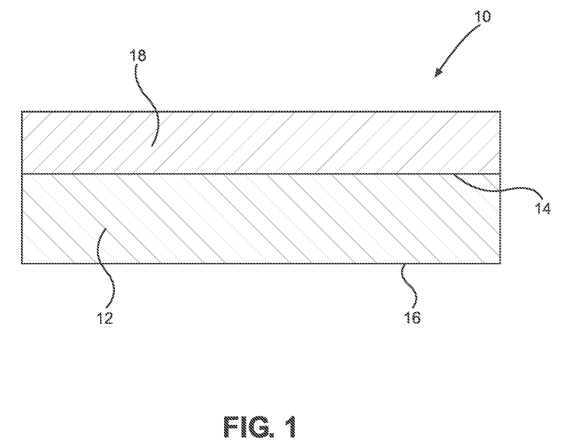

As shown in FIG. 1, the insect trap 10 includes a substrate 12. The substrate 12 includes a first surface 14 and a second surface 16.

In certain embodiments, the substrate 12 maybe formed from a polymeric web. In such instances, the polymeric web typically comprises at least 50 weight percent polyhydroxyalkanoates, preferably at least 80 weight percent polyhydroxyalkanoates, and more preferably at least 90 weight percent polyhydroxyalkanoates.

In other embodiments, the substrate 12 may be formed from a paperboard web having a coating layer applied over a least a portion of the paperboard web. In these embodiments, the coating layer typically comprises at least 50 weight percent polyhydroxyalkanoates, preferably at least 80 weight percent polyhydroxyalkanoates, and more preferably at least 90 weight percent polyhydroxyalkanoates.

According to the present disclosure, different forms of polyhydroxyalkanoates may be used in the substrate. In general, the polyhydroxyalkanoates of the substrate may be either a homopolymer, a copolymer, or a terpolymer. For instance, in some embodiments, the substrate preferably includes poly-3-hydroxybutyrate-co-3-hydroxyhexanoate (“P(3HB-co-3HHx)”). In other embodiments, the substrate preferably includes a terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate having from 5 to 12 carbon atoms.

Moreover, in some embodiments, the polyhydroxyalkanoates in the substrate may be combined with one or more additional biodegradable polymers selected from the group consisting of polycaprolactone, polylactic acid, polybutylene succinate, polybutylene succinate-co-butylene adipate, polybutylene adipate terephthalate, and mixtures thereof.

The insect trap 10 also includes an adhesive 18 which is applied over at least a portion of the substrate first surface 14. In some instances, the adhesive 18 may be applied over portions of both the first surface 14 and the second surface 16 of the substrate 18.

According to the present disclosure, the adhesive typically comprises at least 50 weight percent polyhydroxyalkanoates, and more preferably comprises at least 80 weight percent polyhydroxyalkanoates.

As with the substrate, different forms of polyhydroxyalkanoates may be used in the substrate in accordance with the present disclosure. In general, the polyhydroxyalkanoates of the substrate may be either a homopolymer, a copolymer, or a terpolymer. For instance, in some embodiments, the substrate preferably includes poly-3-hydroxybutyrate-co-3-hydroxyhexanoate (“P(3HB-co-3HHx)”). In other embodiments, the substrate preferably includes a terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate having from 5 to 12 carbon atoms.

In addition to the polyhydroxyalkanoates, the adhesive may also comprise a biodegradable tackifier. In certain embodiments, the adhesive may include for example, a collagen-based tackifier (such as a technical gelatin or an animal or protein glue) or a mucilage tackifier.

Besides the substrate and the attractant, the insect trap also comprises an insect attractant. In some instances, the insect attractant may comprise a pheromone which is attractive to insects. For instance, the insect attractant may comprise a pheromone which is attractive to Diabrotica barberi; Diabrotica undecimpunctata; Diabrotica undecimpunctatahowardiBarber;Cerotomatrifurcata;Hypenascabra;Nezaraviridula; Acrosternumhilare;Euschistusservus;Pseudoplusiaincludens(Walker);Trichoplusiani (Hubner);Anthonomusgrandis;Aphisglycines(Matsumura);Epicautasp.(pennsylvania; pestifera; fabricii); and/ or Chrysodeixis includens.

Alternatively, the insect attractant may be provided as a food source which is attractive to insects. Example of such food-based attractants include oil of thyme, clove oil, geraniol, and eugenol. Other non-food attractants include 2-phenyl ethyl propionate. metadimethoxybenzene, para-dimethoxybenzene, trimethoxybenzene, guaiacol, indole, phenylacetaldehyde, cinnamaldehyde, cinnamonitrile, β-ionone, 4-methoxy cinnamaldehyde, 4-methoxy cinnamonitrile, 4-methoxy-1-vinyl-benzene, 4-methoxy-1-propyl-benzene, 4-methoxy phenyl ethyl ether, 4-methoxy phenyl acetonitrile, allyl benzene, 2-methoxy cinnamaldehyde, cinnamyl acetate, cinnamic acid methyl ester, dihydrocinnamyl aldehyde, benzaldehyde, and phenyl propionitrile.

In some instances, the pheromone or other attractant is may be applied as a coating over at least a portion of the substrate. This may be accomplished either by incorporating the attractant into the adhesive or by applying the attractant as a separate layer over at least a portion of the substrate and/or the adhesive.

Optionally, the insect trap may also include an insecticide in addition to the attractant. However, the insecticide is not considered to be essential to the insect trap of the present disclosure.

If present, the insecticide is preferably an insecticide which is not harmful to crops and/or an insecticide which rapidly degrades into a harmless form. Examples of suitable insecticides which might be used in the insect trap include Neem oil, orspinosyns, flubendaimide, indoxacarb or carbamate, esfenvalerate, permethrin, beta-cyfluthrin, bifenthrin, thiodicarb, acephate, and carbaryl. The insect trap preferably does not contain any insecticide selected from the group consisting of carbofuran, isofenphos, phorate, and terbufos.

Again, however, the insecticide is not considered to be essential to the insect trap of the present disclosure. Thus, in certain embodiments, the insect trap of the present disclosure does not include any insecticide.

While the insect trap 10 according to the present disclosure will include the aforementioned substrate, adhesive, and insect attractant, the substrate of the insect trap may be may be converted or otherwise shaped in one of a variety of final shapes in accordance with the present invention. Thus, the final overall configuration of the insect trap may vary.

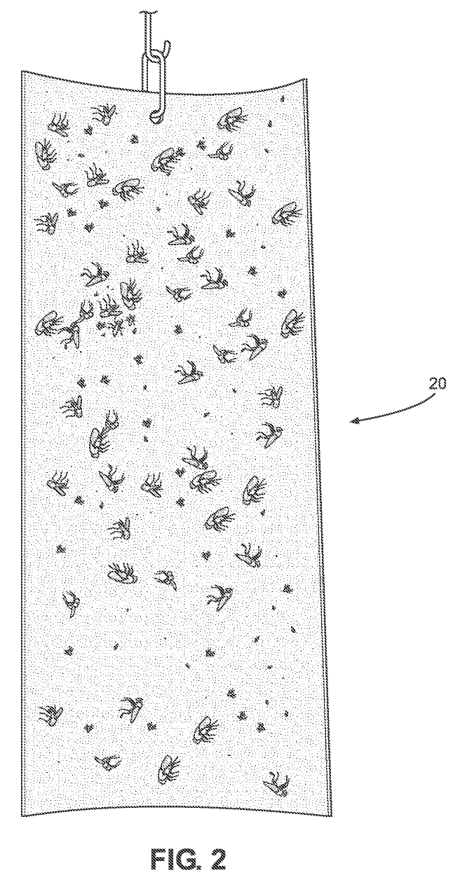

For instance, in certain embodiments, the insect trap may be provided as a strip or sheet 20 which may be suspended from a tree branch or other structure, as illustrated in FIG. 2. The strip or sheet 20 is typically suspended over or near to a planted field. In some instances, the insect trap 10 may be suspended using a hook or clip 16 which also comprises polyhydroxyalkanoates and/or another biodegradable polymer.

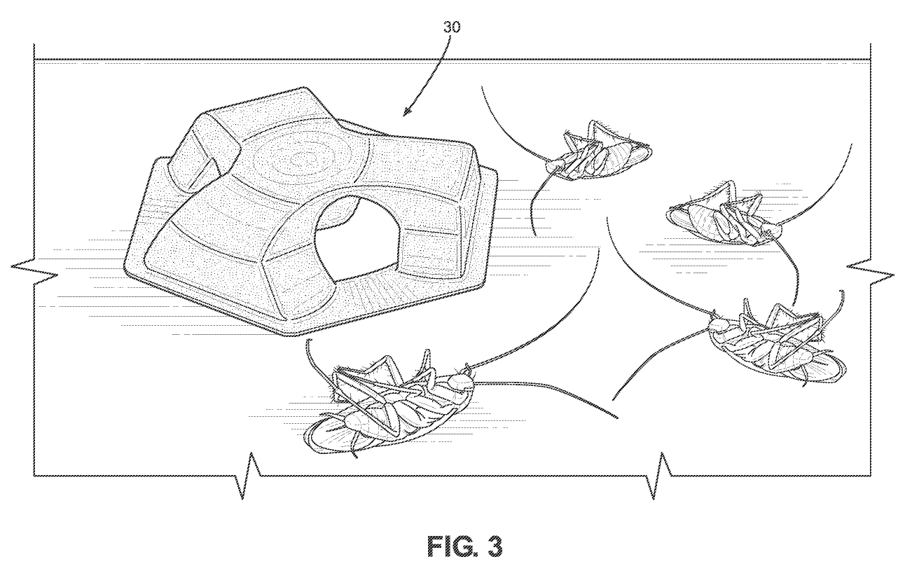

In other embodiments, the insect trap may be provided as an enclosure 30 for trapping crawling or flying insects. As illustrated in FIG. 3, this enclosure 30 may be a small box, funnel, cylindrical, triangular, rectangular, or multisided structure made from polyhydroxyalkanoates with at least one opening for the insects to enter. The enclosure 30 has at least one surface coated with a biodegradable adhesive comprising polyhydroxyalkanoates to which an attractant has been incorporated or sprayed.

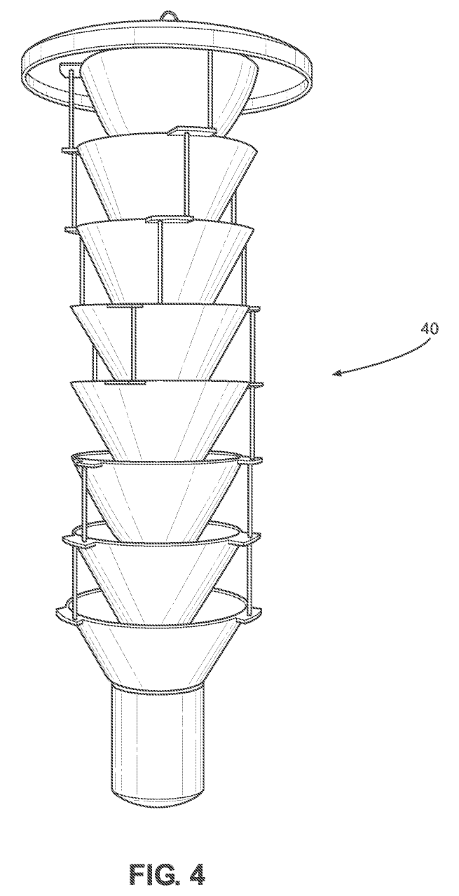

In one embodiment, the insect trap may be a funnel trap 40, which comprises a plurality of funnels made from a polyhydroxyalkanoates, preferably with a top covering to prevent rain drainage, and a lower chamber filled with an adhesive and attractant. An example is illustrated in FIG. 4.

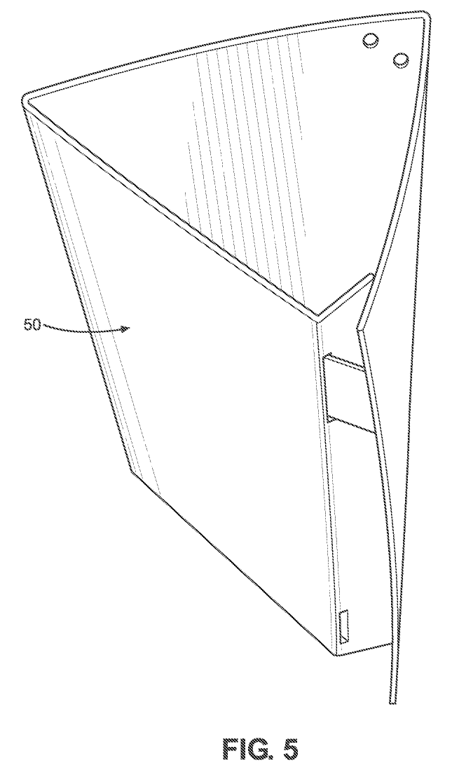

In another embodiment, the insect trap may be a provided as a folding panel trap 50. As shown in FIG. 5, the panel trap is freestanding and comprises a plurality of panels made from a polyhydroxyalkanoates with an adhesive and an attractant added to one or more panels of the trap.

In still another embodiment, the insect trap may be used as a tree band trap which is wrapped around a portion of a tree trunk.

Importantly, the insect trap according to the present disclosure is also biodegradable. According to certain embodiments, the insect trap is preferably biodegradable as determined by ASTM D5988. In certain other embodiments, the insect trap is preferably home compostable as determined by ASTM D6400.

Due to the insect trap being biodegradable and/or compostable, the need to remove and dispose of the insect trap after use is eliminated. Instead, the insect trap may simply be tilled into the soil without a separate step to retrieve and separately dispose of the insect trap.

Thus, the present disclosure also provides a method for capturing insects. According to one embodiment, this method includes the steps of positioning an insect trap over an agricultural field; capturing insects with the trap; and disposing of the trap by burying the trap in the agricultural field.

### EMBODIMENTS

The present disclosure is also further illustrated by the following embodiments:

Embodiment 1. A biodegradable insect trap, comprising:
a substrate having a first surface, wherein the substrate comprises: (1) a polymeric web which comprises at least 50 weight percent polyhydroxyalkanoates or (2) a paperboard web having a coating layer applied over a least a portion of the paperboard web, wherein the coating layer comprises at least 50 weight percent polyhydroxyalkanoates;
an adhesive applied over at least a portion of the substrate first surface, wherein the adhesive comprises at least 50 weight percent polyhydroxyalkanoates; and
an insect attractant.

Embodiment 2. The biodegradable insect trap of Embodiment 1, wherein the substrate comprises an elongate sheet which is suspended from an overhead support.

Embodiment 3. The biodegradable insect trap of Embodiment 1 or 2, wherein the substrate is formed into an enclosure for trapping insects.

Embodiment 4. The biodegradable insect trap of any of the preceding Embodiments, wherein the substrate is formed into a box for trapping insects, wherein the substrate first surface is disposed inside of the box.

Embodiment 5. The biodegradable insect trap of any of the preceding Embodiments, wherein the insect attractant comprises a pheromone which is attractive to insects.

Embodiment 6. The biodegradable insect trap of any of the preceding Embodiments, wherein the insect attractant comprises a pheromone which is attractive to Diabroticabarberi; Diabroticaundecimpunctata; Diabroticaundecimpunctatahowardi

Barber; Cerotoma trifurcata; Hypena scabra; Nezara viridula; Acrosternum hilare; Euschistus servus; Pseudoplusia includens (Walker); Trichoplusia ni (Hubner); Anthonomusgrandis;Aphisglycines(Matsumura);Epicautasp.(pennsylvania;pestifera; fabricii); and/ or Chrysodeixis includens.

Embodiment 7. The biodegradable insect trap of Embodiment 5 or 6, wherein the pheromone is applied as a coating over at least a portion of the substrate.

Embodiment 8. The biodegradable insect trap of any of the preceding Embodiments, wherein the substrate comprises at least 80 weight percent polyhydroxyalkanoates.

Embodiment 9. The biodegradable insect trap of any of the preceding Embodiments, wherein the substrate comprises poly-3-hydroxybutyrate-co-3-hydroxyhexanoate (“P(3HB-co-3HHx)”).

Embodiment 10. The biodegradable insect trap of any of the preceding Embodiments, wherein the substrate comprises a terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate having from 5 to 12 carbon atoms.

Embodiment 11. The biodegradable insect trap of any of the preceding Embodiments, wherein the substrate comprises at least one addition one biodegradable polymer selected from the group consisting of polycaprolactone, polylactic acid, polybutylene succinate, polybutylene succinate-co-butylene adipate, polybutylene adipate terephthalate, and mixtures thereof.

Embodiment 12. The biodegradable insect trap of any of the preceding Embodiments, wherein the adhesive comprises poly-3-hydroxybutyrate-co-3-hydroxyhexanoate (“P(3HB-co-3HHx)”).

Embodiment 13. The biodegradable insect trap of any of the preceding Embodiments, wherein the adhesive comprises a terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate having from 5 to 12 carbon atoms.

Embodiment 14. The biodegradable insect trap of any of the preceding Embodiments, wherein the adhesive further comprises a biodegradable tackifier.

Embodiment 15. The biodegradable insect trap of any of the preceding Embodiments, wherein the insect trap is biodegradable as determined by ASTM D5988.

Embodiment 16. The biodegradable insect trap of any of the preceding Embodiments, wherein the insect trap is home compostable as determined by ASTM D6400.

Embodiment 17. The biodegradable insect trap of any of the preceding Embodiments, wherein the insect trap does not comprise an insecticide.

Embodiment 18. A method for capturing insects, comprising the steps of: positioning an insect trap over an agricultural field; capturing insects with the trap; and disposing of the trap by burying the trap in the agricultural field,

wherein the insect trap comprises a substrate having a first surface, wherein the substrate comprises: (1) a polymeric web which comprises at least 50 weight percent polyhydroxyalkanoates or (2) a paperboard web having a coating layer applied over a least a portion of the paperboard web, wherein the coating layer comprises at least 50 weight percent polyhydroxyalkanoates, an adhesive applied over at least a portion of the substrate first surface, wherein the adhesive comprises at least 50 weight percent polyhydroxyalkanoates, and an insect attractant.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and

its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A biodegradable insect trap, comprising:
a substrate having a first surface, wherein the substrate comprises: (1) a polymeric web which comprises at least 50 weight percent polyhydroxyalkanoates or (2) a paperboard web having a coating layer applied over a least a portion of the paperboard web, wherein the coating layer comprises at least 50 weight percent polyhydroxyalkanoates;
an adhesive applied over at least a portion of the substrate first surface, wherein the adhesive comprises at least 50 weight percent polyhydroxyalkanoates; and
an insect attractant.

2. The biodegradable insect trap of claim 1, wherein the substrate comprises an elongate sheet which is suspended from an overhead support.

3. The biodegradable insect trap of claim 1, wherein the substrate is formed into an enclosure for trapping insects.

4. The biodegradable insect trap of claim 1, wherein the substrate is formed into a box for trapping insects, wherein the substrate first surface is disposed inside of the box.

5. The biodegradable insect trap of claim 1, wherein the insect attractant comprises a pheromone which is attractive to insects.

6. The biodegradable insect trap of claim 1, wherein the insect attractant comprises a pheromone which is attractive to Diabroticabarberi; Diabrotica undecimpunctata; DiabroticaundecimpunctatahowardiBarber; Cerotomatrifurcata; Hypenascabra; Nezaraviridula; Acrosternumhilare; Euschistusservus; Pseudoplusiaincludens(Walker); Trichoplusiani(Hubner); Anthonomusgrandis; Aphisglycines(Matsumura); Epicautasp.(pennsylvania; pestifera; fabricii); and/or Chrysodeixisincludens.

7. The biodegradable insect trap of claim 5, wherein the pheromone is applied as a coating over at least a portion of the substrate.

8. The biodegradable insect trap of claim 1, wherein the substrate comprises at least 80 weight percent polyhydroxyalkanoates.

9. The biodegradable insect trap of claim 1, wherein the substrate comprises poly-3-hydroxybutyrate-co-3-hydroxyhexanoate (“P(3HB-co-3HHx)”).

10. The biodegradable insect trap of claim 1, wherein the substrate comprises a terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate having from 5 to 12 carbon atoms.

11. The biodegradable insect trap of claim 1, wherein the substrate comprises at least one addition one biodegradable polymer selected from the group consisting of polycaprolactone, polylactic acid, polybutylene succinate, polybutylene succinate-co-butylene adipate, polybutylene adipate terephthalate, and mixtures thereof.

12. The biodegradable insect trap of claim 1, wherein the adhesive comprises poly-3-hydroxybutyrate-co-3-hydroxyhexanoate (“P(3HB-co-3HHx)”).

13. The biodegradable insect trap of claim 1, wherein the adhesive comprises a terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate having from 5 to 12 carbon atoms.

14. The biodegradable insect trap of claim 1, wherein the adhesive further comprises a biodegradable tackifier.

15. The biodegradable insect trap of claim 1, wherein the insect trap is biodegradable as determined by ASTM D5988.

16. The biodegradable insect trap of claim 1, wherein the insect trap is home compostable as determined by ASTM D6400.

17. The biodegradable insect trap of claim 1, wherein the insect trap does not comprise an insecticide.

18. A method for capturing insects, comprising the steps of: positioning an insect trap over an agricultural field;
capturing insects with the trap; and
disposing of the trap by burying the trap in the agricultural field, wherein the insect trap comprises
a substrate having a first surface, wherein the substrate comprises: (1) a polymeric web which comprises at least 50 weight percent polyhydroxyalkanoates or
(2) a paperboard web having a coating layer applied over a least a portion of the paperboard web, wherein the coating layer comprises at least 50 weight percent polyhydroxyalkanoates,
an adhesive applied over at least a portion of the substrate first surface, wherein the adhesive comprises at least 50 weight percent polyhydroxyalkanoates, and
an insect attractant.
